(19) United States
(12) Patent Application Publication
(10) Pub. No.: US 2024/0353822 A1
(43) Pub. Date: Oct. 24, 2024

(54) Run-to-Run Controller for Semiconductor Manufacturing

(71) Applicant: Robert Bosch GmbH, Stuttgart (DE)

(72) Inventor: Ulrich Potthoff, Dresden (DE)

(21) Appl. No.: 18/637,640

(22) Filed: Apr. 17, 2024

(30) Foreign Application Priority Data
Apr. 19, 2023 (DE) 10 2023 203 585.5

(51) Int. Cl. G05B 19/418

(52) U.S. Cl. CPC G05B 19/41865; G05B 2219/32252; G05B 2219/45031

(57) ABSTRACT

A method for adjusting a process controller in order to manufacture one or a plurality of components in production is disclosed. The method includes (i) obtaining input data characterizing one or a plurality of components, (ii) determining clusters in the input data, (iii) grouping the components into the determined cluster, and (iv) determining a parameterization of a specified process step for the one or plurality of components or subsequent components by way of a R2R controller, depending on the measurement results and the grouping.

This application claims priority under 35 U.S.C. § 119 to patent application no. DE 10 2023 203 585.5, filed on Apr. 19, 2023 in Germany, the disclosure of which is incorporated herein by reference in its entirety.

The disclosure relates to a method for improving a run-to-run controller (R2R controller) by taking into account links between component/production contexts, as well as an apparatus, a computer program, and a machine readable storage medium which are configured to perform the method.

### BACKGROUND

It is known that R2R controllers receive measurements from processed wafers. The measurements are typically physical measurements on the wafer. The physical measurements can also be referred to as product parameters. These include, e.g., in-line measurements that can be measured on the product, preferably by means of physical measuring devices. In contrast, there are process parameters (processing time, polishing pressure, exposure rate, gas flow) that describe a manufacturing step (recipe) on the wafer.

By way of example, measurement methods include: layer thickness measurement (THK), e.g. spectroscopic ellipsometry of multiple superimposed transparent layers, structural measurement by atomic force microscopy (AFM), e.g. trench depth, imaging methods (CDSEM), e.g. geometric width, hole diameter, critical dimension, defect number and pattern, (DFU), resistance measurement (RES), specific resistance.

Based on the measurements, a recipe for the next processing step (process step) of the wafer is then recommended by means of a R2R controller in order to possibly readjust the next processing step accordingly if the measurements are not within a specified ideal range.

The processing step is controlled by means of piece goods control, meaning that the recipe for the subsequent processing step for a wafer or batch (batch of wafers) is influenced by the R2R controller. A recipe characterizes the respective manufacturing or processing step, e.g. exposure, etching, depositing, polishing. However, the R2R controller does not intervene during the processing of the wafer/batch. This type of control is also referred to as R2R process control.

Run-to-run controllers for the manufacture of semiconductors are known. For example, see: Moyne, J. (2014). Run-to-run Control in Semiconductor Manufacturing, in: Baillieul, J., Samad, T. (eds) Encyclopedia of Systems and Control. Springer, London. https://doi.org/10.1007/978-1-4471-5102-9_255-1.

The R2R controller essentially serves to compensate for interference variables, e.g. longer-term drift in manufacturing, by means of corresponding recipe adaptations during subsequent processes in order to thereby maintain relevant in-line parameters at the respective desired target variable.

R2R controllers are capable of distinguishing between control contexts. Grouping is typically performed according to what are referred to as control contexts (number of batches having the same or similar product specification). In simple terms, the R2R controller can assign a product with a control context and can provide correspondingly adapted recipes based on the assigned control context. For example, a product A is to be assigned to a first control context. The controller can select the respective etching operation, including its parameterization, based on this control context.

A static grouping has the disadvantage that the feedback from the R2R controllers can be used to a very limited extent for less frequently occurring “low runner” products. This is because the fact that the low runners are rarely processed means that the controller receives a small amount of feedback compared to products that are often processed. Furthermore, there is currently no feedback loop so that the controller learns from low runners for the frequent products and vice versa.

Therefore, an object of the disclosure is to provide a dynamic group. More precisely stated: How can an optimal R2R operating regime be ensured under the side condition that volume products run undisturbed, participate in the best possible way to one another, and by-products can still be processed as best as possible.

One advantage of the disclosure is an improved learning capacity of the R2R controller, regardless of how often a product is processed. Furthermore, the method has the advantage that only further information is made available to the R2R controller and this information is thus itself not changed.

### SUMMARY

A first aspect of the disclosure relates to a method for adjusting a process control used to control a production machine during the manufacture of a component in production or manufacturing. The component is preferably a semiconductor component, such as a sensor or chip. It should be noted that the process control determined according to the method of the first aspect can be used to manufacture one or a plurality of components. For example, semiconductor components on a wafer or in a lot/batch may be processed substantially equally according to the determined process control.

The method begins by obtaining and providing input data characterizing the component. This is followed by determining clusters in the input data. A cluster can be understood to mean an amount of data points having similar properties. The component is then grouped based on its input data into one of the determined clusters within which input data is located. This is followed by a determination of a parameterization of a specified process step for the component by means of a R2R controller, depending on the measurement results and the grouping.

It is proposed that a similarity between the clusters, in particular cluster centers, is determined in addition to the clusters. Depending on the determined similarities, a link between the clusters is determined. The parameterization is then determined additionally depending on the links between the groups. Preferably, the links are normalized.

Further advantageous embodiments of the first aspect of the disclosure are the subject of discussion set forth below.

In further aspects, the disclosure relates to an apparatus and to a computer program, which are each configured to perform the aforementioned methods, and to a machine-readable storage medium on which said computer program is stored.

### BRIEF DESCRIPTION OF THE DRAWINGS

Embodiments of the disclosure are explained in greater detail below with reference to the accompanying drawings. In the drawings:

FIG. 1 schematically shows a known R2R controller;

FIG. 2 schematically shows an embodiment of the inventive R2R controller with dynamic grouping of contexts;

FIG. 3 schematically shows one embodiment of the inventive R2R controller for three control contexts;

FIG. 4 schematically shows a flow chart of one embodiment of the inventive method.

### DETAILED DESCRIPTION

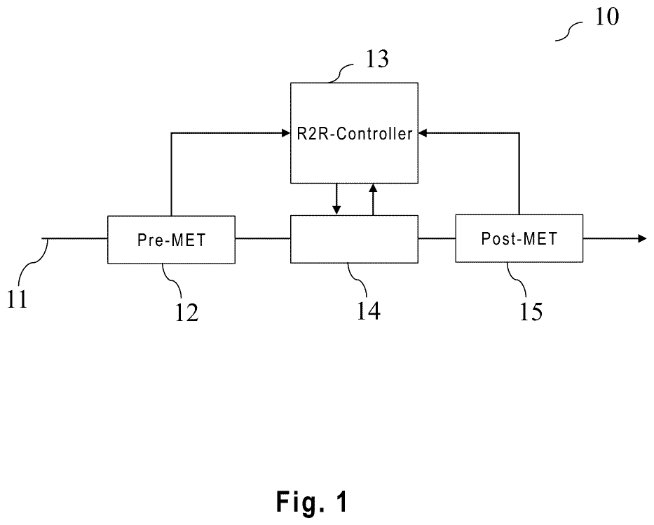

FIG. 1 schematically shows an information flow diagram 10 of a R2R controller 13, which is known from the prior art.

The information flow diagram 10 shows a process flow 11 for manufacturing a semiconductor component. In a first step, one or a plurality of physical measurements 12 are performed on a wafer. A measurement 12 may be a thickness, width, depth, etc. of the wafer. The measurement results MET are then forwarded and provided to the R2R controller 13.

Depending on the measurement results MET, the R2R controller 13 will adjust a process step 14 for the wafer. In other words, the R2R controller 13 outputs an adjustment for the process step 14 depending on the measurement results MET so that, after performing the process step 14, the processed wafer ideally has product parameters within a specified range of values.

Optionally, after performing process step 14 according to the adjustment output by the R2R controller 13, one or a plurality of downstream physical measurements 15 can be performed on the processed wafer. The measurement results obtained post-MET can be provided to the R2R controller 13 as feedback so that the latter can provide better adjustments for subsequent process steps 14, depending on the subsequently obtained measurement results.

In summary, it can be said that the R2R process control according to FIG. 1 comprises a pre-measurement, processing, and optionally a follow-up measurement. The R2R controller 13 pursues a control target: setting process parameters (controlled variables) within specification limits based on a target value and automatically correcting, in a model-based and self-learning manner, target deviations by the targeted adaptation of manipulated variables, e.g. processing time, gas flows, etc.

The control law itself is typically a mathematical optimization problem with a target function, optionally with side conditions using stored state variables and a feedback principle based on system theory (closed loop control).

It is then proposed that the R2R controller 13 typically uses what are referred to as control contexts (number of batches having the same or similar product specification) consisting of a set of descriptive attributes such as product, recipe, process step, tool, chamber, and/or others for grouping. Many contexts are unchangeable/static, i.e., they are typically applied once, and other contexts (e.g., less frequently occurring “low runners”) are difficult to assign and thus contribute little to the overall result. It should be noted that new contexts may need to be assigned and/or contexts may disappear at end-of-life.

Preferably, each control context is subject to individual rules, e.g. an admissible number of processing operations without remeasurement and/or admissible service life of the facility, without or with processing of a different type (ageing effects, concurrency).

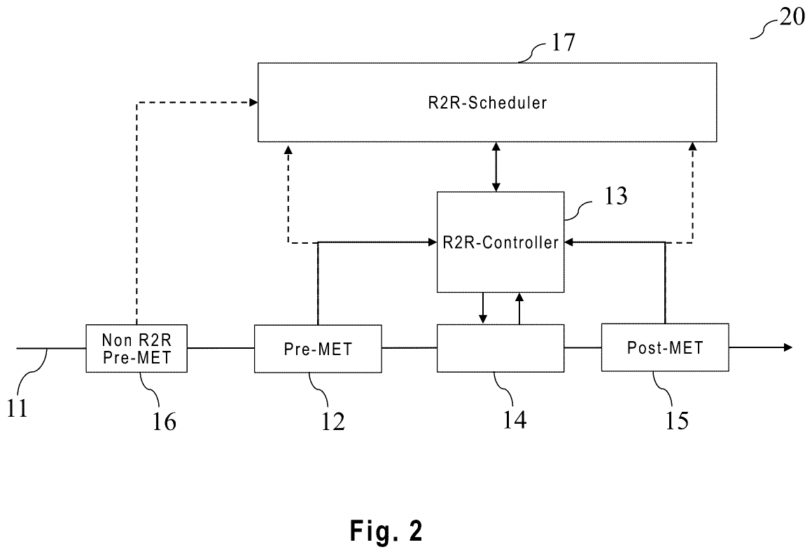

FIG. 2 schematically shows an information flow diagram 20 of an embodiment of the R2R controller according to the disclosure with dynamic grouping. The illustrated embodiment in FIG. 2 differs, among other things, from the embodiment in FIG. 1 in that the R2R controller receives a grouping of products into control contexts and a link between the groupings from a higher-level coordinating instance—hereinafter referred to as R2R scheduler 17—as additional input.

As indicated in FIG. 2 by dashed lines, the R2R scheduler 17 receives various measurement results. These measurement results are processed by the R2R scheduler 17 for grouping and linking. Database entries 16, physical measurement results 12 from the wafer and/or downstream physical measurement results 15 on the processed wafer of the R2R scheduler 17 can thereby be provided to the R2R scheduler 17.

In the embodiment in FIG. 2, the R2R controller 13 outputs an adjustment/parameterization for the process step 14 depending on the measurement results pre-MET, and optionally depending on the downstream physical measurement results post-MET, and depending on the determined linking of the R2R scheduler 17.

The R2R scheduler 17 is preferably also configured to check or monitor the quality of the context grouping in a predictive, automatic, self-learning manner and optionally make suggestions for regrouping, in particular without interfering with the core control algorithm (e.g., model predictive control MPC, PID, EWMA). The R2R scheduler 17 is preferably also configured to—optionally and as necessary—trigger automatic controller resets in case of reassignments.

The R2R scheduler 17 is further preferably configured to check whether selected control contexts are still appropriate. Numerical criteria or logical criteria can be used as a criterion for control with respect to an appropriate/optimal regulation context. A root mean square error (RMSE) or target size deviations can be used as a numeric criterion, the former characterizing, e.g., a deviation in terms of changes in cluster centers over time with respect to the original cluster center or deviations from product-specific targets. A service life, elapsed time, or elapsed quantity of a control context can be used as a logical criterion.

The R2R scheduler 17 is further preferably configured to reorganize the assignment/rearrangement/reordering of the control contexts.

The R2R scheduler 17 is further preferably configured to take into account further side conditions, such as incompatibilities of contexts. The incompatibilities may be known based on domain-specific prior knowledge. For example, if two products or contexts will have different control behavior, e.g. positive or negative lacquer in lithography, or coating of a common group of very thick layers (around 10 km) but separation from the context group of thin layers (around 10 nm), this prior knowledge can be taken into account accordingly in the side conditions.

The R2R scheduler 17 can determine the groupings using self-learning clustering of feedforward and/or feedback contexts. Historical data are used for this purpose. It is conceivable that the groupings are validated based on forecasts for short, medium, or longer time horizons.

The R2R scheduler 17 is further preferably configured to include further requirements for batch piloting (e.g., automatic reset and pilot requirement to MES), which include, for example, time requirements for the processing sequence.

The R2R scheduler 17 is further preferably configured to evaluate a control performance of individual control contexts and draw (heuristic and deterministic) conclusions from it, e.g. to initiate a regrouping. The control performance may be determined using known metrics: mean square target deviation (2-norm based), mean amount deviation (1-norm based), maximum target deviation (infinite-norm based).

The R2R scheduler 17 can be embedded in a data mining framework (manufacturing execution system MES, data warehouse DWH, data lake, etc.). Preferably, the input data of the R2R scheduler 17 are the measured and manipulated variables used directly for control. It is contemplated that the input data also include further process parameters (e.g., non-R2R) that typically occur upstream in the process flow. The R2R scheduler 17 preferably uses R2R-Pre-MET, R2R-Post-MET, and process information. Particularly preferably, the R2R scheduler 17 can additionally access further sources of information, such as: measurement information, logistical information, timing, information about previous usage habits.

The R2R scheduler 17 then links the control contexts by determining weights in a link matrix K. The link matrix K may be different or identical for feedforward, manipulated, and control variables.

Periodic and dynamic reassignment of the control contexts is accomplished by recalculating the link matrix K at regular intervals, or in an event-driven manner.

The recalculation of the link matrix can be performed on the basis of various criteria, e.g., for numerical weightings=>RMSE, target deviations, for logistical assignments (non-numerical, categorical), e.g. logistics, service life, product mix.

By adding the R2R scheduler 17 and the R2R scheduler 17 communicating with the R2R controller 13, the R2R scheduler 17 can be easily integrated into the existing plant control system without any major changes.

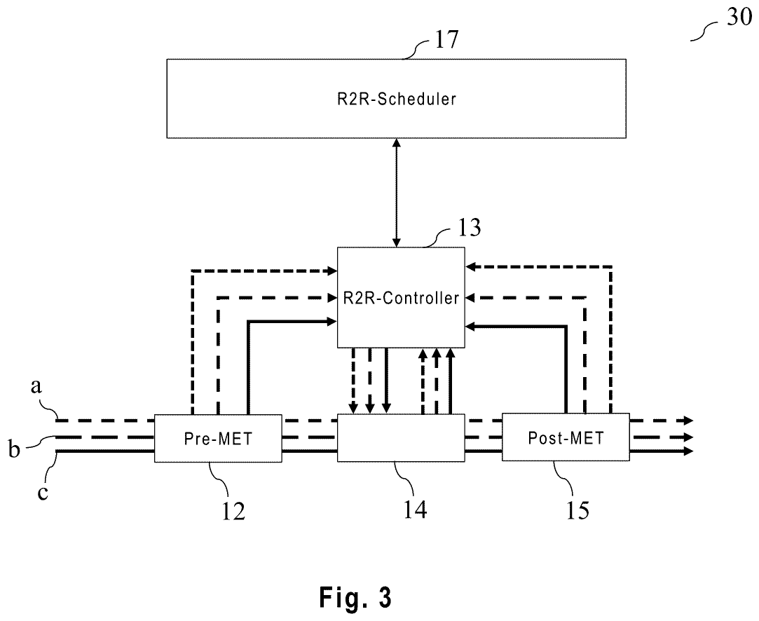

FIG. 3 schematically shows a grouping by way of example. Preferably, the grouping is configured once and then maintained.

The grouping is, e.g., performed according to FIG. 3 with regard to process steps. For example, the different line types a,b,c represent different structural features (deep etchings, structural widths, etc.). Accordingly, products are serially processed: Products are first processed according to line types a, then according to line types b or c, etc.

The R2R controller 13 learns about the different products from each other by processing them separately using the same production machines and by linking them. For example, the controller learns, for each of the products, how far the processing tool (e.g., process chamber, polishing head, etc.) should be closed. The product that was most frequently processed is the fastest to learn. This learning can then also be provided for the other products via the link matrix. For example, aging effects that occur over time are detected more quickly and this knowledge is shared between the different products.

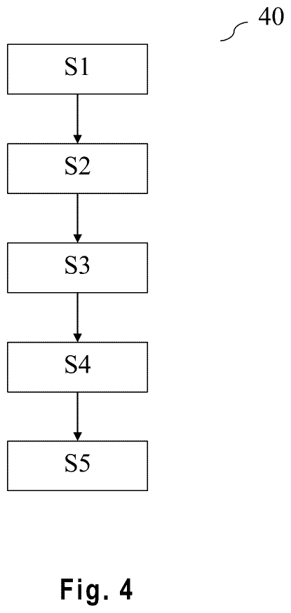

FIG. 4 schematically shows a flow chart 40 of an embodiment of an adaptive control method of the R2R controller 13 based on a dynamic grouping of products.

The method starts with a provision S1 of the input data specified hereinabove, e.g. pre-MET measurements for the R2R scheduler 17.

In the following step S2, a clustering algorithm is applied to this input data, e.g. by means of K-means or other known clustering algorithms. Preferably, the input data have timestamps, and clustering is performed using the input data whose time stamps lie within a predefined time span. It is contemplated that the input data are pre-processed. The pre-processing can be performed using methods such as redundancies, e.g. by means of a PCA.

The determined clusters from step S2 then represent the grouping. In other words, a grouping is determined based on the input data and the clustering algorithm.

In the subsequent step S3, the clusters determine which input data points, in particular measurement points of which products, are within the respective cluster. These products having measurement points within the cluster are then assigned to the respective group belonging to that cluster. After this step S3, a (new) grouping of the products is thus provided.

It should be noted that the grouping is independent of controller types (e.g. MPC, EWMA, PID, etc.). This is accomplished using a higher-level scheduler (organizer), wherein the scheduler determines the link matrix and then transfers it.

This new grouping is transferred to the R2R controller (step S4), which uses this new grouping during operation. The batches of a grouping can perform a controller update (usually recalculation of the control loop) for their own context, but only proportionally for nearby/similar or no update at all for contexts of a different type.

In optional step S5, the R2R controller uses the grouping and determines, among other things, a parameterization for the process step 14, depending on the grouping. Optionally, control of a facility is then performed using the determined parameterization.

In preferred embodiments of method 40, the following modifications can be made:

In a first preferred embodiment, links between the groups are determined. In step S2, determining the cluster centers, distances between the clusters can be determined. The distances can be determined using a mathematical distance dimension, e.g. an L1-norm/total norm, ∥x∥₁=Σᵢ₌₁ⁿ|xᵢ| or using a Euclidean norm ∥x∥₂²=Σᵢ₌₁ⁿ(xᵢ)². The determined distances can be understood as links.

Alternatively, correlations between the clusters can be determined and the links selected according to the determined correlations.

It is conceivable that the links between the clusters are determined, e.g. via (0 . . . 1) normalized correction coefficients, depending on the determined distances and correlations. Preferably, the accumulation via the links and via the clusters is 1. In other words, the links are normalized.

Two examples follow of link matrices having three control contexts, delinked vs. easily linked:

$${K}_{entkoppelt} = ( \begin{matrix}1 & 0 & 0 \\ 0 & 1 & 0 \\ 0 & 0 & 1\end{matrix} )$$

$${K}_{gekoppelt} = ( \begin{matrix}0.7 & 0.2 & 0.1 \\ 0 & 0.8 & 0.2 \\ 0 & 0 & 1\end{matrix} )$$

It is contemplated that the link values will be entered into the link matrix if they exceed a specified threshold value. This ensures that the groupings are not continuously readjusted, which may result in adverse oscillation behavior of the link values. In other words, the robustness is increased.

The link matrix is then transferred to the R2R controller 13. The latter can take the links into account in its optimization steps and thus benefit from the experience of different products. The optimization method (algorithm) itself need not be changed. Only the correction coefficients of the link matrices give the individual batches different weightings/importance for the controller update process. Similar to a “weighted regression”, certain data points are included more strongly in the calculation of the update, others less strongly. In other words, the disadvantage of the low runners of the low feedback of the R2R controllers 13 is overcome by the links. When self-optimizing the controller, the controller can use feedback from the other products, weighted by the link values. In other words, the R2R controller 13 collectively learns about different products.

In a second preferred embodiment, a reduction of the number of groups is performed. If there are fewer groups after step S2 of clustering than were previously used, the link matrix can then be reduced. For example, the original three groups then become two groups. As a result, a line (and column) of the link matrix can be deleted and products thereby merged. For example, structural features of 10 and 12 (e.g., width, depth, diameter) that are close together are merged into a structural feature of 11, whereby permitted tolerances in particular are complied with. It is therefore possible to merge contexts.

In a third preferred embodiment, expert knowledge can be taken into account. Side conditions established by an expert may exist. In addition, the R2R scheduler 17 will set elements of the link matrix to 0.

The embodiments of method 40 described hereinabove can be used as follows. In a first application, the method 40 is used for a R2R controller reset. If cleaning of a chamber has been performed, then a controller reset from product A can be performed. The controller is also reset for product B if product B is in the same group as A. In other words, an event-driven reset of the controllers for other products is performed.

In a second application, the method 40 is used to influence priorities of products through the R2R scheduler 17. If, for example, a processing tool is to be fully worn, e.g. due to less stress, then the R2R scheduler 17 can choose products with low stresses. The wear information can be obtained by the R2R scheduler 17 from a third source, such as a database (non-R2R pre-MET).

In a third application, the method 40 is used to rapidly incorporate a new product. It is contemplated that, for a new product (which has not yet been manufactured), the link matrix can be used to refer back to what has already been learned.

What is claimed is:

1. A method for adjusting a process controller in order to manufacture one or a plurality of components in production, comprising:
(S1) obtaining input data characterizing the one or a plurality of components;
(S2) determining clusters in the input data;
(S3) grouping the components into the determined cluster based on their input data; and
(S4) determining a parameterization of a specified process step for the one or plurality of components or subsequent components by way of a R2R controller, depending on the measurement results and the grouping.

2. The method according to claim 1, wherein:
a respective similarity between the clusters is determined in addition to the clusters,
a link between the clusters is determined depending on the determined similarities, and
the parameterization is determined additionally, depending on the links between the groups.

3. The method according to claim 2, wherein the similarities between the clusters are determined based on a distance dimension and/or a correlation between the respective clusters.

4. The method according to claim 1, wherein:
the links are combined into a link matrix,
the entries of the matrix are normalized, and
the parameterization is determined depending on the link matrix.

5. The method according to claim 1, wherein:
given a similarity between two clusters greater than a specified threshold value, combining these two clusters.

6. The method according to claim 1, wherein:
performing steps S1 to S4 again at specified times or upon the occurrence of a specified event, and
subsequently checking whether the R2R controller should be reset and/or whether a current grouping should be replaced by the new grouping from step S3.

7. An apparatus which is configured to perform the method according to claim 1.

8. A computer program comprising instructions which, when the program is executed by a computer, prompt the latter to perform the method according to claim 1.

9. A machine-readable storage medium on which the computer program according to claim 8 is stored.

10. The method according to claim 1, wherein:
a respective similarity between the cluster centers is determined in addition to the clusters,
a link between the clusters is determined depending on the determined similarities, and
the parameterization is determined additionally, depending on the links between the groups.
